(19) United States
(12) Patent Application Publication
(10) Pub. No.: US 2024/0158052 A1
(43) Pub. Date: May 16, 2024

(54) Combination Fishing Net Mud Spike

(71) Applicant: Gregory Robinson, Tyler, TX (US)

(72) Inventor: Gregory Robinson, Tyler, TX (US)

(21) Appl. No.: 18/389,215

(22) Filed: Nov. 13, 2023

Related U.S. Application Data
(60) Provisional application No. 63/424,544, filed on Nov. 11, 2022.

(51) Int. Cl. B63B 21/00; A01K 75/00

(52) U.S. Cl. CPC B63B 21/00; A01K 75/00; B63B 2021/003

(57) ABSTRACT

A combination fishing net mud spike may attach or clamp to a variety of types of personal watercraft (PWC) including, but not limited to, bass boats, pontoon boats, canoes, and/or kayaks, to secure the PWC while fishing. The mud spike may be used to secure the PWC in shallow waters for fishing. Further, the ring portion of the combination fishing net mud spike may be used to secure around a tree. Accordingly, the mud spike and/or the ring portion may be used to hold the PWC in place for fishing or other water activities, and the combination fishing net mud spike does not require being near a dock/pier or piling to be used. However, the combination fishing net mud spike may be secured to a dock/pier. The ring portion may include slots or other securing mechanisms to receive a fishing net.

### CROSS-REFERENCE TO RELATED APPLICATION

The present application is a non-provisional of, and claims priority to, U.S. Patent Application No. 63/424,544 filed Nov. 11, 2023, the disclosure of which is incorporated by reference in its entirety.

### FIELD OF THE DISCLOSURE

The present disclosure generally relates to fishing, and more particularly to a combination fishing net mud spike that may connect to personal watercraft (PWC) or a dock for fishing or other water activities.

### BACKGROUND

When PWC, including but not limited to, bass boats, pontoon boats, canoes, and/or kayaks, are being used for fishing or other water activities, the PWC is often secured to the dock/pier, a piling, or even a tree to provide stabilization. However, this can limit the user's flexibility to select where he/she fishes or conducts water activities, as it may be dictated by the location of the dock/pier and/or the piling. Further, fishing nets or poles can sometimes not be stable enough to use, particularly in catching large fish.

### SUMMARY

Embodiments of the present disclosure may provide a combination fishing net mud spike that may attach or clamp to a variety of types of personal watercraft (PWC) including, but not limited to, bass boats, pontoon boats, canoes, and/or kayaks, to secure the PWC while fishing. The mud spike may be used to secure the PWC in shallow waters for fishing. Further, the ring portion of the combination fishing net mud spike may be used to secure around a tree. Accordingly, the mud spike and/or the ring portion may be used to hold the PWC in place for fishing or other water activities, and the combination fishing net mud spike does not require being near a dock/pier or piling to be used. However, the combination fishing net mud spike may be secured to a dock/pier in some embodiments of the present disclosure. The ring portion may include slots or other securing mechanisms to receive a fishing net. The combination fishing net mud spike also may include a handle portion at a top of the mud spike to permit a user to manipulate the combination fishing net mud spike in embodiments of the present disclosure.

Additional embodiments of the present disclosure may provide a combination fishing net mud spike that is capable of attaching or clamping to a personal watercraft to secure the personal watercraft when fishing or other water activities, the combination fishing net mud spike comprising: a mud spike portion; a ring portion attached to the mud spike portion having one or more securing mechanisms to receive a fishing net; a mounting portion that is capable of attaching or clamping to the personal watercraft, the mounting portion positioned above the ring portion on the mud spike portion; and a handle portion at a top of the mud spike portion that permits a user to manipulate the combination fishing net mud spike, the handle having a hinge portion that allows the handle to be movable relative to the mud spike. The personal watercraft may be selected from the group comprising: bass boats, pontoon boats, canoes, and kayaks. The ring portion may secure the combination fishing net mud spike around a tree. The combination fishing net mud spike may be capable of being secured to a dock or pier. The one or more securing mechanisms may be slots. The mounting portion may be a clamp or a bracket. The mounting portion may be removable from the combination fishing net mud spike. The mounting portion may be movable to more than one position on the combination fishing net mud spike. The mounting portion may be affixed to a bar that is capable of being folded. The bar may have a hinge portion that folds the mounting portion against the mud spike when not in use. The mounting portion may be affixed to a pole that is capable of being folded. The handle portion may be securable at a right angle relative to a topmost part of the mud spike portion. The ring portion may be secured to the mud spike portion through a hinge so that the ring portion is foldable against the mud spike portion for transport or when not in use. The ring portion may be capable of being used as part of an anchor ring. The mud spike portion may be telescopic and/or adjustable.

### BRIEF DESCRIPTION OF THE DRAWINGS

For a more complete understanding of this disclosure, reference is now made to the following description, taken in conjunction with the accompanying drawings, in which:

FIGS. 1A and 1B depicts views of a combination fishing net mud spike according to an embodiment of the present disclosure; and

FIG. 2 depicts another view of a combination fishing net mud spike according to an embodiment of the present disclosure;

FIG. 3 depicts use of a combination fishing net mud spike for fishing in an embodiment of the present disclosure; and

FIG. 4 depicts attachment of a combination fishing net mud spike to a dock according to an embodiment of the present disclosure.

### DETAILED DESCRIPTION

Embodiments of the present disclosure may provide a combination fishing net mud spike. The combination fishing net mud spike may attach or clamp to a variety of types of personal watercraft (PWC) including, but not limited to, bass boats, pontoon boats, canoes, and/or kayaks, to secure the PWC while fishing. The mud spike may be used to secure the PWC in shallow waters for fishing. Further, the ring portion of the combination fishing net mud spike may be used to secure around a tree in embodiments of the present disclosure. Accordingly, the mud spike and/or the ring portion may be used to hold the PWC in place for fishing or other water activities, and the combination fishing net mud spike according to embodiments of the present disclosure does not require being near a dock/pier or piling to be used. However, as described herein, the combination fishing net mud spike may be secured to a dock/pier in some embodiments of the present disclosure.

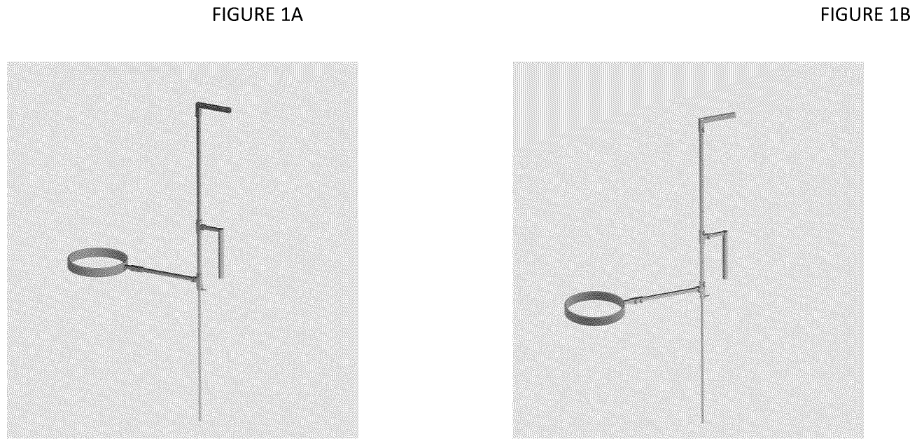

FIGS. 1A and 1B depict views of a combination fishing net mud spike according to an embodiment of the present disclosure. The combination fishing net mud spike may have a mounting bracket or a clamp, such as a C clamp, that may connect to a PWC. However, it should be appreciated that other types of mounting brackets, clamps or securing mechanisms may be used without departing from the present disclosure. While embodiments of the present disclosure may include the securing mechanism as part of the combination fishing net mud spike, it should be appreciated that there may be embodiments where the securing mechanism may be removable from the combination fishing net mud spike such as, for example, if a mounting bracket or other securing mechanism is already provided on a PWC or dock/pier. In such embodiments, the combination fishing net mud spike may have a mechanism to receive the mounting bracket or other securing mechanism present on the PWC or dock/pier.

The securing mechanism may be positioned on a mud spike above where a ring is secured to the mud spike. It should be appreciated that the securing mechanism may be movable to more than one position on the mud spike without departing from the present disclosure. The securing mechanism may be affixed to a bar that may be foldable, such as through a hinge portion, to fold the securing mechanism against the mud spike portion when not in use (i.e., when not attached to a PWC or for transport). While a hinge portion is referred to herein, another axis or juncture mechanism may be utilized without departing from the present disclosure. While a bar is referred to herein, it should be appreciated that poles or other similar items may be used without departing from the present disclosure. Further, while the bar may be formed of metal, it should be appreciated that the bar may be formed of plastic or other materials that may be capable of securely holding the securing mechanism in place relative to the mud spike portion in embodiments of the present disclosure.

The mud spike portion may include a handle having a hinge portion that allows the handle to be movable relative to the mud spike portion. For example, the handle may be secured at a right angle relative to the topmost part of the mud spike portion so that a user may hold the handle to put the mud spike into position. However, the hinge portion may permit the handle to be folded onto the mud spike portion, such as for transport. The handle also may be used to manage the fishing net when secured in the ring portion as will be described in more detail herein.

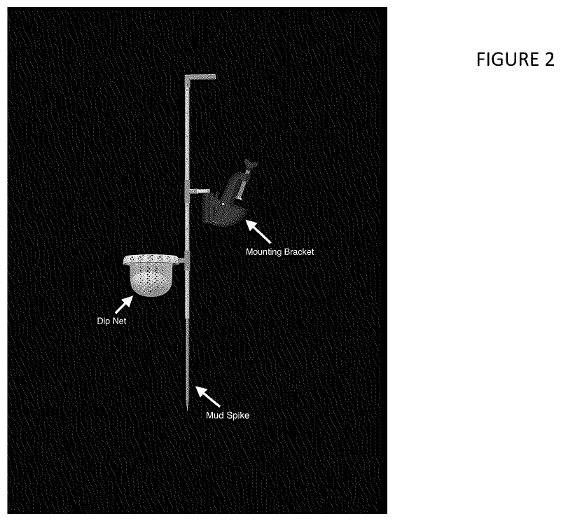

The combination fishing net mud spike according to embodiments of the present disclosure may include a ring that may be secured to the upper portion of the mud spike portion. As described with respect to other portions of the combination, it should be appreciated that the ring may be secured through a hinge portion so that the ring may be folded against the upper portion of the mud spike for transport or when not in use. The ring may be used to secure the combination fishing net mud spike around a tree or piling that may be found in the water to further secure the PWC into position for fishing or other water activities. However, the ring also may include slots that may receive a fishing net or a dip net (FIG. 2). Accordingly, the user may secure a fishing net in the ring, and the construction of the combination fishing net mud spike may provide a more stable means to catch larger fish and pull them into a PWC. It should be appreciated that the ring may receive a fishing net or dip net of various shapes and sizes without departing from the present disclosure. It also should be appreciated that the ring may be used as part of an anchor ring in embodiments of the present disclosure.

In embodiments of the present disclosure, the combination fishing net mud spike may include a lower portion of the mud spike portion. The lower portion of the mud spike portion may be fastened to the hinge portion that secures the ring to the upper portion of the mud spike portion. However, there may be other embodiments of the present disclosure where the lower portion may be secured or fastened directly to the upper portion of the mud spike. For example, FIG. 2 depicts another view of a combination fishing net mud spike according to an embodiment of the present disclosure. As depicted herein, the upper portion and the lower portion of the mud spike may be secured to one another and may be in a form that the upper and lower portions are integral to one another with the ring secured directly to the mud spike. It also should be appreciated that the mud spike may be telescopic and/or adjustable in embodiments of the present disclosure.

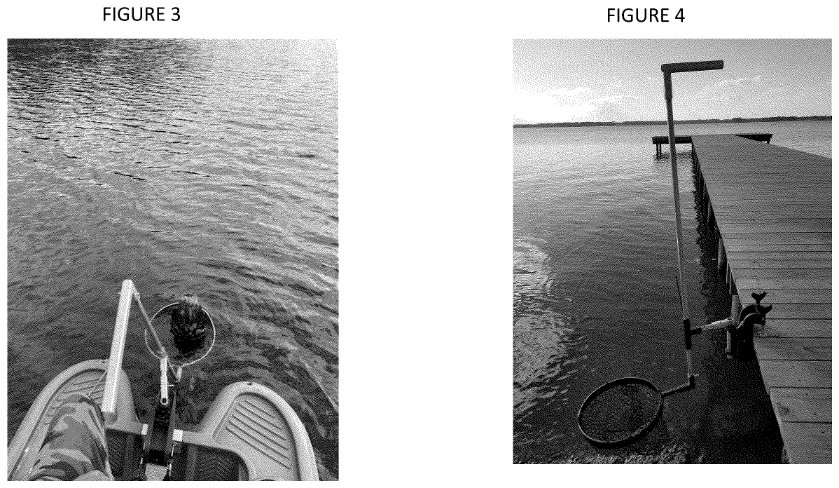

FIG. 3 depicts use of a combination fishing net mud spike for fishing in an embodiment of the present disclosure. In this embodiment, the clamp or other fastening mechanism may be secured to a PWC. A fishing net may be attached or secured to the ring. The handle may be positioned at a level where the user may hold or otherwise use the handle to control the fishing net and lift the fishing net when fish have been caught in the net.

FIG. 4 depicts attachment of a combination fishing net mud spike to a dock according to an embodiment of the present disclosure. While other embodiments have been described as connecting to the combination fishing net mud spike to a PWC, it should be appreciated that the clamp or other securing mechanism may be used to attach to a dock or other platform in embodiments of the present disclosure. As depicted herein, the clamp or other securing mechanism may be attached to the dock and a fishing net may be attached to the ring for fishing in a stationary position. This may be useful in situations where a user may wish to lower the fishing net into the water and not be required to hold the fishing net in position. However, once fish have been caught in the net, the combination fishing net mud spike may be easily lifted using the handle at the uppermost portion of the mud spike.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A combination fishing net mud spike that is capable of attaching or clamping to a personal watercraft to secure the personal watercraft when fishing or other water activities, the combination fishing net mud spike comprising:
a mud spike portion;
a ring portion attached to the mud spike portion having one or more securing mechanisms to receive a fishing net;
a mounting portion that is capable of attaching or clamping to the personal watercraft, the mounting portion positioned above the ring portion on the mud spike portion; and
a handle portion at a top of the mud spike portion that permits a user to manipulate the combination fishing net mud spike, the handle having a hinge portion that allows the handle to be movable relative to the mud spike.

2. The combination fishing net mud spike of claim 1, wherein the personal watercraft is selected from the group comprising:
bass boats, pontoon boats, canoes, and kayaks.

3. The combination fishing net mud spike of claim 1, wherein the ring portion secures the combination fishing net mud spike around a tree.

4. The combination fishing net mud spike of claim 1, wherein the combination fishing net mud spike is capable of being secured to a dock or pier.

5. The combination fishing net mud spike of claim 1, wherein the one or more securing mechanisms are slots.

6. The combination fishing net mud spike of claim 1, wherein the mounting portion is a clamp or a bracket.

7. The combination fishing net mud spike of claim 1, wherein the mounting portion is removable from the combination fishing net mud spike.

8. The combination fishing net mud spike of claim 1, wherein the mounting portion is movable to more than one position on the combination fishing net mud spike.

9. The combination fishing net mud spike of claim 1, wherein the mounting portion is affixed to a bar that is capable of being folded.

10. The combination fishing net mud spike of claim 9, wherein the bar has a hinge portion that folds the mounting portion against the mud spike when not in use.

11. The combination fishing net mud spike of claim 1, wherein the mounting portion is affixed to a pole that is capable of being folded.

12. The combination fishing net mud spike of claim 1, wherein the handle portion is securable at a right angle relative to a topmost part of the mud spike portion.

13. The combination fishing net mud spike of claim 1, wherein the ring portion is secured to the mud spike portion through a hinge so that the ring portion is foldable against the mud spike portion for transport or when not in use.

14. The combination fishing net mud spike of claim 1, wherein the ring portion is capable of being used as part of an anchor ring.

15. The combination fishing net mud spike of claim 1, wherein the mud spike portion is telescopic and/or adjustable.
